(19) United States
(12) Patent Application Publication
(10) Pub. No.: US 2001/0022768 A1
(43) Pub. Date: Sep. 20, 2001

(54) Optical pickup apparatus and laser diode chip

(76) Inventor: Shinichi Takahashi, Tokorozawa-City (JP)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/789,931

(22) Filed: Feb. 22, 2001

(30) Foreign Application Priority Data
Feb. 22, 2000 (JP) 2000-44628

(51) Int. Cl. G11B 7/135

(52) U.S. Cl. 369/120; 369/121; 369/112.23

(57) ABSTRACT

A laser diode chip for an optical pickup apparatus, in which a plurality of laminated light emitting portions which emit laser beams having different wavelengths are formed on a substrate, and light emitting points of the plurality of light emitting portions are placed at positions separated by different lengths from each other in the laminate direction from the same plane of the substrate.

### BACKGROUND OF THE INVENTION

1. Field of the Invention

The present invention relates to an optical pickup apparatus for reading information from a plurality of recording media of different types by emitting a plurality of laser beams of different wavelengths and a laser diode chip for the optical pickup apparatus.

2. Description of the Related Background Art

Generally, a semiconductor laser device is used as a light source of an optical pickup apparatus for playing an optical information recording medium such as CD, DVD, or the like.

To play back the recording medium, the light emission wavelength and the numerical aperture (NA) of an objective lens of the semiconductor laser device which is used for playing a CD and for playing a DVD are different from each other. For example, in the case of the DVD, the wavelength is equal to 650 nm and the NA is equal to 0.6 and, in the case of the CD, the wavelength is equal to 780 nm and the NA is equal to 0.45.

To play different kinds of discs such as CD, DVD, and the like by one disc player, therefore, an optical pickup apparatus having therein light sources of two wavelengths of 650 nm and 780 nm is being used. FIG. 1 shows an example of the optical pickup apparatus.

According to the optical pickup apparatus shown in FIG. 1, a laser device 1 for emitting a laser beam having a wavelength of 650 nm, a laser device 2 for emitting a laser beam having a wavelength of 780 nm, a synthesizing prism 3, a half mirror 4, a collimator lens 5, and an objective lens 6 are sequentially arranged. Further, a photodetector 7 is placed on another optical axis which is branched from the half mirror 4. In the construction, since an optical system starting with the synthesizing filter 3 and extending to an optical disc 8 is used in common for the CD and DVD, in both cases, the light emitted from the laser device passes through the synthesizing filter 3 and, thereafter, is guided toward the optical disc 8 along an optical axis Y. The objective lens 6 used here is a lens having double focal points and different focal positions, provided in accordance with the two wavelengths. A spherical aberration which is caused by different thicknesses of surface substrates of the CD and DVD can be, consequently, suppressed.

In the construction, however, since a synthesizing prism or the like is needed, a large number of parts is required and the costs of production are high. Further, because it is necessary to match the positions of the two laser devices and the synthesizing prism, the construction becomes complicated, and it is difficult to make adjustments to the device.

### SUMMARY OF THE INVENTION

In consideration of the problems, it is an object of the present invention to provide an optical pickup apparatus and a laser diode chip, in which a construction of the apparatus for using a plurality of laser beams having different wavelengths can be simplified and miniaturized.

A laser diode chip according to the present invention is for an optical pickup apparatus in which a plurality of light emitting portions having laminate structures are formed on a substrate for emitting laser beams of different wavelengths, wherein respective light emitting points of the plurality of light emitting portions are located at positions separated by different lengths in the laminate direction from the same plane of the substrate.

A light-pickup device according to the present invention comprises a light emitting device in which a plurality of light emitting portions having laminate structures for emitting laser beams having different wavelengths are formed on a substrate and the laser beams are selectively emitted from one of the plurality of light emitting portions; and an optical system for guiding the laser beams emitted from the light emitting device to a recording surface of a recording medium and guiding a laser beam reflected by the recording surface of the recording medium to a photosensing device, wherein respective light emitting points of the plurality of light emitting portions are located at positions separated by different lengths in the laminate direction from the same plane of the substrate, the optical system includes an astigmatism element for supplying astigmatism to the laser beam, the light detecting device has four-split light receiving portions corresponding to the respective laser beams having the different wavelengths in an arranged manner, and all the center parting lines of the light receiving surfaces in the array direction of the respective four-split light receiving portions are arranged to form the same straight line, the light emitting device is placed so that the sum of an angle formed by the major axis line of an elliptic spot formed on the recording medium by the laser beam and the tangential line of the track of the recording medium and an angle formed by the same plane and a straight line connecting the light emitting points of the plurality of light emitting portions becomes a predetermined angle, and the light detecting device is placed to make the center parting line parallel to the tangential line of the track on the light receiving surface.

Furthermore, a light-pickup device according to the present invention comprising a light emitting device in which a plurality of light emitting portions having laminate structures for emitting laser beams having different wavelengths are formed on a substrate and the laser beams are selectively emitted from one of the plurality of light emitting portions; and an optical system for guiding the laser beams emitted from the light emitting device to a recording surface of a recording medium and guiding a laser beam reflected by the recording surface of the recording medium to a photosensing device, wherein respective light emitting points of the plurality of light emitting portions are located at positions separated by different lengths in the laminate direction from the same plane of the substrate, the optical system includes an astigmatism element for supplying astigmatism to the laser beam, the light detecting device has four-split light receiving portions corresponding to the respective laser beams having the different wavelengths in an arranged manner, and all the center parting lines of the light receiving surfaces in the array direction of the respective four-split light receiving portions are arranged to form the same straight line, the light emitting device is placed so that an angle formed by the major axis line of an elliptic spot formed on the recording medium by the laser beam and the tangential line of the track of the recording medium is equal to an angle formed by the same plane and a straight line connecting the light emitting points of the plurality of light emitting portions, and the light detecting device is placed to make the center parting line perpendicular to the tangential line of the track on the light receiving surface.

### BRIEF DESCRIPTION OF THE DRAWINGS

FIG. 1 is a block diagram showing an example of a conventional optical pickup apparatus;

FIG. 2 is a diagram showing the configuration of an optical pickup apparatus according to the present invention and a path of a laser beam when an optical disc is a DVD;

FIG. 3 is a diagram showing a path of a laser beam when an optical disc is a CD;

FIG. 4 is a cross section showing details of a semiconductor laser device;

FIG. 5 is a diagram showing a light spot on the track of a disc;

FIG. 6 is a diagram showing a semiconductor laser device fixed on an insulating submount;

FIG. 7 is a diagram showing the arrangement of the light receiving surfaces of respective light receiving elements;

FIG. 8 is a diagram showing positions of light spots formed by a first laser beam on the light receiving surfaces in FIG. 7;

FIG. 9 is a diagram showing positions of light spots formed by a second laser beam on the light receiving surfaces in FIG. 7;

FIG. 10 is a diagram showing the arrangement of the light receiving surface of respective light receiving elements;

FIG. 11 is a diagram showing positions of light spots formed by a first laser beam on the light receiving surfaces in FIG. 10;

FIG. 12 is a diagram showing positions of light spots formed by a second laser beam on the light receiving surfaces in FIG. 10; and

FIG. 13 is a diagram showing the relation between the arrangement of a semiconductor laser device and the light spots on the track of a disc, and the positions of light receiving surfaces, as another embodiment of the present invention.

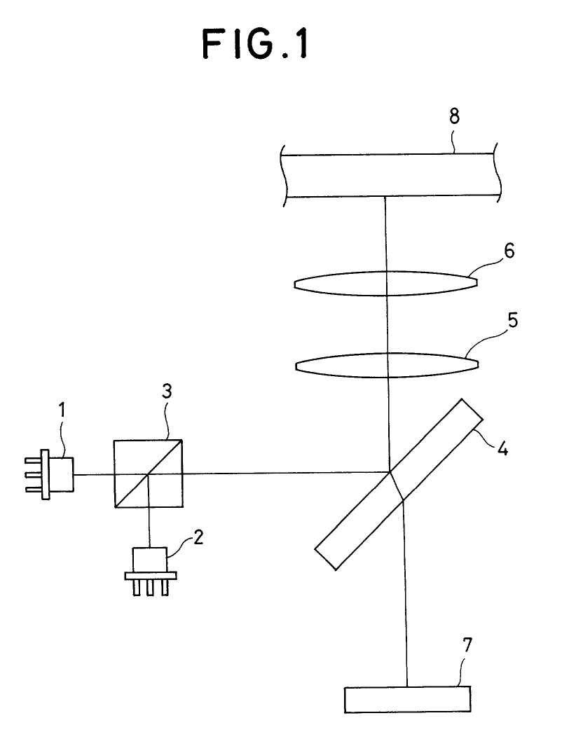

### DETAILED DESCRIPTION OF THE PREFERRED EMBODIMENTS

Embodiments of the present invention will now be described in detail hereinafter with reference to the accompanying drawings.

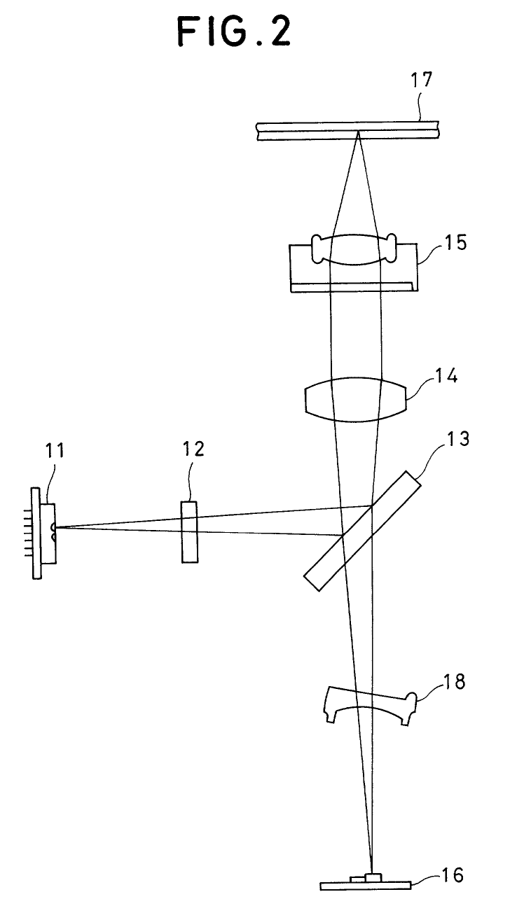

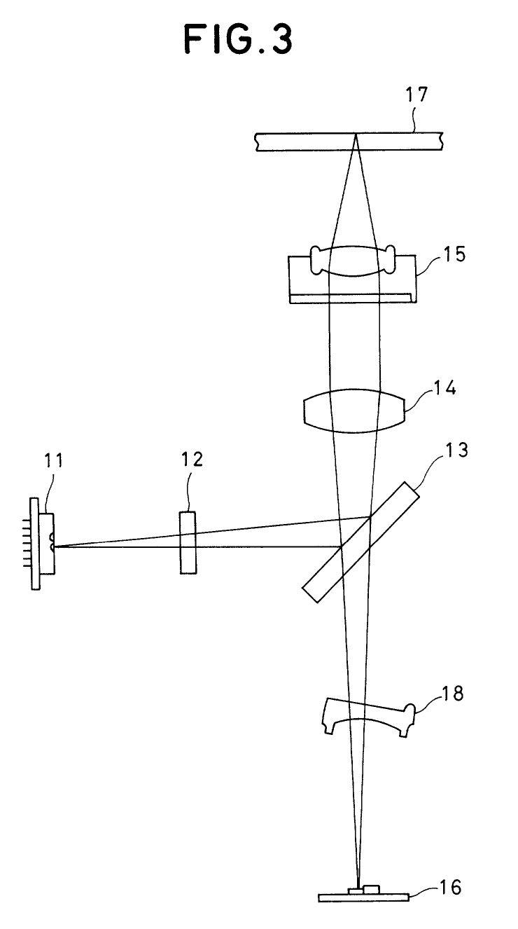

FIGS. 2 and 3 show an optical system of an optical pickup apparatus according to the invention. The optical pickup apparatus has a semiconductor laser device 11 for emitting two laser beams having different wavelengths. In the optical pickup apparatus, the laser beam emitted from the semiconductor laser device 11 reaches a half mirror (beam splitter) 13 through a grating 12. The grating 12 is provided for separating the laser beam into a plurality of light beams (0th order light, ±1 primary lights). The 0th order light is used for focusing servo control. The ±1 primary lights are used for tracking servo control.

The half mirror 13 reflects the incident laser beam at an angle of almost 90° for the incidence of the laser beam. The direction of the reflected laser beam is equal to a direction toward an optical disc 17 as a recording medium. A collimator lens 14 and an objective lens 15 are arranged between the half mirror 13 and optical disc 17.

The collimator lens 14 converts the laser beam from the half mirror 13 into a parallel light and supplies it to the objective lens 15. The objective lens 15 is a lens having double focal points and converges the laser beam of the parallel light onto a recording surface of the disc 17. The recording surface of the disc 17 reflects the laser beam. The laser beam reflected by the recording surface is converted into a parallel laser beam by the objective lens 15 and collimator lens 14 and, thereafter, linearly passes through the half mirror 13. A cylindrical lens 18 and a photodetector 16 are sequentially arranged in the optical axial direction which passes through the half mirror 13. The cylindrical lens 18 is an astigmatism generating device for forming an astigmatism.

FIG. 2 shows the case where a DVD is used as an optical disc 17. A first laser beam having a wavelength of 650 nm is emitted from the semiconductor laser device 11. FIG. 3 shows the case where a CD is used as an optical disc 17. A second laser beam having a wavelength of 780 nm is emitted from the semiconductor laser device 11.

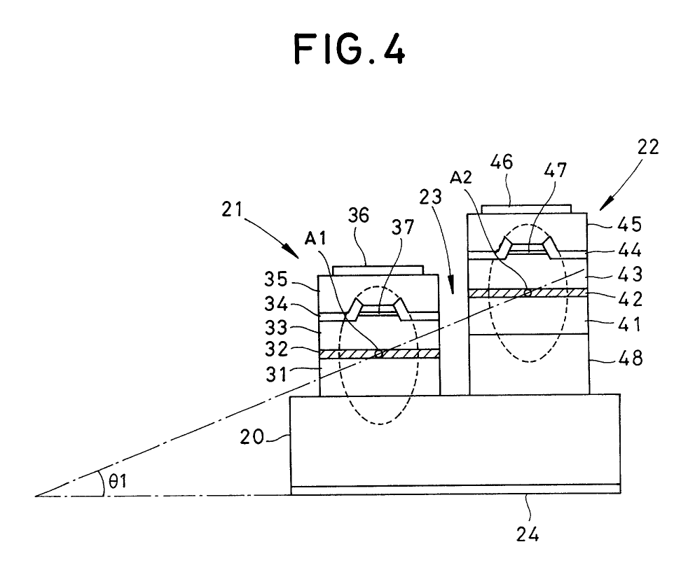

FIG. 4 shows an external view of a chip of the semiconductor laser device 11. As shown in FIG. 4, the semiconductor laser device 11 is provided in the form of a single chip. A first light emitting portion 21 having a first light emitting point A1 for emitting the first laser beam of the wavelength of 650 nm and a second light emitting portion 22 having a second light emitting point A2 for emitting the second laser beam of the wavelength of 780 nm are formed on one principal surface of a single n-type GaAs substrate 20 through a separating groove 23. A back electrode 24 serving as a common electrode of both light emitting portions 21 and 22 is formed on the other principle surface of the substrate 20.

The first light emitting portion 21 has an n-type AlGaInP clad layer 31, a strain quantum well active layer 32, a p-type AlGaInP clad layer 33, an n-type GaAs layer 34, a p-type GaAs layer 35, and an electrode 36 in that order onto the GaAs substrate 20. A cross section of the clad layer 33 is formed in a trapezoidal shape in its center portion. The n-type GaAs layer 34 is formed so as to cover the clad layer 33 excluding the trapezoidal top surface. A p-type GaInP layer 37 is formed on the trapezoidal top surface. The first light emitting point A1 is located in the strain quantum well active layer 32.

In a manner similar to the first light emitting portion 21, the second light emitting portion 22 has an n-type AlGaInP clad layer 41, a strain quantum well active layer 42, a p-type AlGaInP clad layer 43, an n-type GaAs layer 44, a p-type GaAs layer 45, and an electrode 46 in that order. A cross section of the clad layer 43 is formed in a trapezoidal shape in its center portion. The n-type GaAs layer 44 is formed so as to cover the clad layer 43 excluding the trapezoidal top surface. A p-type GaInP layer 47 is formed on the trapezoidal top surface. The second light emitting point A2 is located in the strain quantum well active layer 42. An interval between an optical axis from the first light emitting point A1 and an optical axis from the second light emitting point A2 is set to, for example, 100 μm.

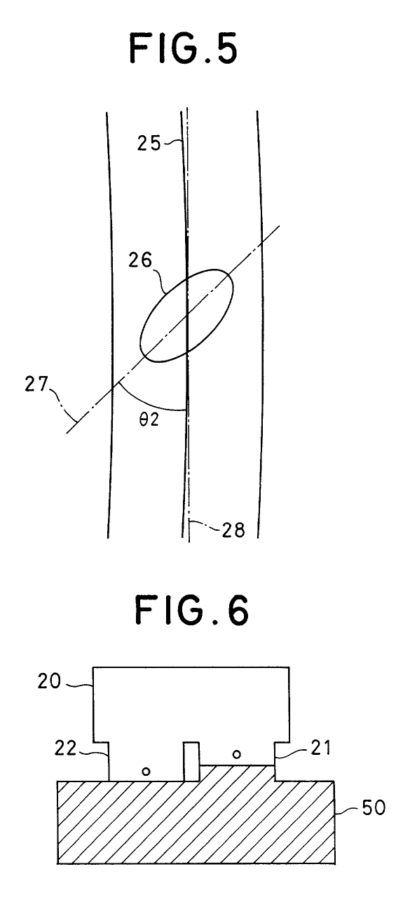

When the angle formed by a straight line connecting the first light emitting point A1 and the second light emitting point A2 and a straight line parallel to the surface of the common electrode 24 is θ1 as shown in FIG. 4 and the angle formed by a major axis 27 of an elliptic spot light 26 formed as to be described below on a track 25 of the optical disc 17 and a tangential line 28 of the track 25 is θ2 as shown in FIG. 5, the semiconductor laser 11 is placed so as to establish the following relation:

θ1+θ2=90°

The relation makes the straight line connecting the first light emitting point A1 and the second light emitting point A2 parallel to the track tangential line of a disc to be played.

The semiconductor laser device 11 is fixed on an insulating submount 50 as shown in FIG. 6 and covered by a casing member (not shown).

The semiconductor laser device 11 selectively generates either the first laser beam or the second laser beam in accordance with a control signal from a laser driving unit (not shown). Although both of the first and second laser beams are not simultaneously emitted, a center axis X1 of the first laser beam and a center axis X2 of the second laser beam are substantially parallel. Each of the emitted first and second laser beams has an elliptic shape as shown by a broken line in FIG. 4. In the invention, a center axis of the laser beam corresponds to a line passing through the center of the distribution of light intensity on the cross section of the laser beam.

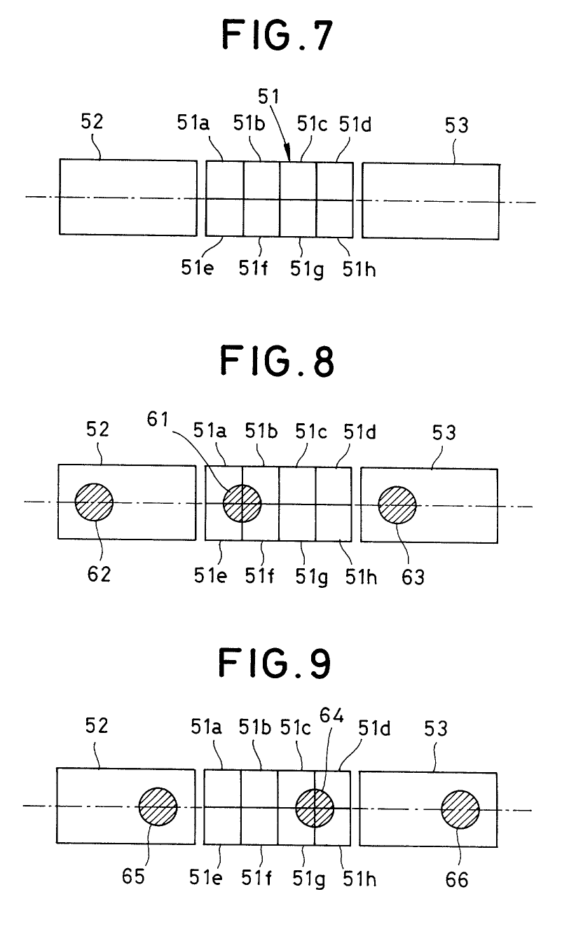

The photodetector 16 has three independent light receiving elements 51 to 53 as shown in FIG. 7. The light receiving surfaces of the light receiving elements 51 to 53 are situated on a plane perpendicular to the optical axis, and have the shape of a rectangle respectively. The light receiving elements 51 to 53 are arranged in a line in the longitudinal direction thereof. The light receiving element 51 is positioned between the light receiving elements 52 and 53. The light receiving surface of the light receiving element 51 is divided into eight to be composed of eight light receiving elements 51a to 51h. That is, the light receiving surface of the light receiving element 51 is divided into eight by a dividing line for dividing into two equal parts in the longitudinal direction and three dividing lines for dividing into four equal parts perpendicular to the dividing line for the two parts. Each of the eight light receiving elements 51a to 51h of the light receiving element 51 generates an output signal corresponding to light receiving intensity at the light receiving surface. Each of the light receiving elements 52 and 53 does not have a divided light receiving surface, and generates an output signal corresponding to light receiving intensity at the light receiving surface. In FIG. 7, an alternate long and short dash line shows the center line which is common to each of the light receiving surfaces of the light receiving elements 51 to 53. The photodetector 16 is placed to make the center line parallel to the track tangential line of a disc to be played. Thus, the tangential line of the track where a light spot is formed corresponds to the center line.

In the above construction, the first or second laser beam emitted from the semiconductor laser device 11 is separated to a plurality of light beams (0th order light, ±1 primary lights) by the grating 12 as mentioned above and, thereafter, reflected by the half mirror 13. The laser beam reflected by the half mirror 13 is converted into a parallel beam by the collimator lens 14 and reaches the objective lens 15. The laser beam is converged onto the recording surface of the disc 17 by the objective lens 15 and forms an elliptic light spot.

The central point of an elliptic light spot formed by the first laser beam and the central point of an elliptic light spot formed by the second laser beam are positioned on the track of the disc 17. This is because, as described above, the relation of θ1+θ2=90° is established between the angle θ1 formed by a straight line connecting the first light emitting point A1 and the second light emitting point A2 and a straight line parallel to the surface of the common electrode 24 and the angle θ2 formed by the major axis of an elliptic spot light formed on the track of the optical disc 17 to be described later and the tangential line of the track. This also means that the arrangement of the light receiving elements 51 to 53 can be directed to the direction of the track or the direction perpendicular to the track direction.

The beam which was modulated by an information pit and reflected by the recording surface of the disc 17 passes through the objective lens 15 and collimator lens 14, is returned to the half mirror 13, is separated here from an optical path from the semiconductor laser device 11, and enters the light receiving surfaces of each of the light receiving elements 51 to 53 of the photodetector 16 through the cylindrical lens 18. The reflected light of 0th order light from the disc 17 is supplied to the light receiving element 51, and the respective reflected lights of ±1 primary lights from the disc 17 are supplied to the light receiving elements 52 and 53.

When the first laser beam having a wavelength of 650 nm is emitted from the first light emitting portion 21 and an elliptic light spot, which is formed on the recording surface of the disc 17 by the first laser beam, is focused and positioned on a track, round light spots 61 to 63 are formed on the light receiving surfaces of the light receiving elements 51 to 53 respectively at the photodetector 16 as shown in FIG. 8. At the light receiving element 51, the round light spot 61 is formed so as to have the center thereof at the center of the division crossing of the light receiving surfaces of the light receiving elements 51a, 51b, 51e, and 51f. At the light receiving elements 52 and 53, the round light spots 62 and 63 are formed at positions respectively separate by predetermined intervals from the light spot 61 of the light receiving element 51. That is, the light spot 62 is positioned on the opposite side to the light receiving element 51 from the center in the longitudinal direction on the light receiving surface of the light receiving element 52. On the light receiving surface of the light receiving element 53, the light spot 63 is positioned on the side of the light receiving element 51 from the center in the longitudinal direction. The direction of the dividing line for dividing the light receiving surfaces of the light receiving elements 51a and 51e from the light receiving surfaces of the light receiving elements 51b and 51f corresponds to the track direction of the disc 17, with the correspondence relationship, the light spot 61 is formed on the light receiving surfaces.

When a second laser beam having a wavelength of 780 nm is emitted from the second light emitting portion 22 and an elliptic light spot, which is formed on the recording surface of the disc 17 by the second laser beam, is focused and positioned on a track, round optical spots 64 to 66 are formed on the light receiving surfaces of the light receiving elements 51 to 53 respectively at the photodetector 16 as show in FIG. 9. The round light spot 64 is formed so as to have the center thereof at the center of the division crossing of the light receiving surfaces of the light receiving elements 51c, 51d, 51g and 51h at the light receiving element 51. The round light spots 65 and 66 are formed at positions respectively separate by predetermined intervals from the light spot of the light receiving element 51 at the light receiving elements 52 and 53. That is, the light spot 65 is positioned on the side of the light receiving element 51 from the center in the longitudinal direction on the light receiving surface of the light receiving element 52, and the light spot 66 is positioned on the opposite side to the light receiving element 51 from the center in the longitudinal direction on the light receiving surface of the light receiving element 53. The direction of the parting line for dividing the light receiving surfaces of the light receiving elements 51c and 51g from the light receiving surfaces of the light receiving elements 51d and 51h corresponds to the track direction of the disc 17, with the correspondence relationship, a light spot 64 is formed on the light receiving surfaces.

In accordance with output signals of the light receiving elements 51a to 51h, a read signal RF and a focus error signal FE are generated. In accordance with output signals of the light receiving elements 52 and 53, a tracking error signal TE is generated. Assuming that the output signals of the light receiving elements 51a to 51h are Aa to Ah in that order and the output signals of the light receiving elements 52 and 53 are B and C in that order, when a first laser beam having the wavelength of 650 nm is emitted from the first light emitting portion 21, the read signal RF is:

RF=Aa+Ab+Ae+Af

the focus error signal FE is:

FE=(Aa+Af)−(Ab+Ae)

and the tracking error signal TE is:

TE=B−C

When a second laser beam having the wavelength of 780 nm is emitted from the second light emitting portion 22, the read signal RF is:

RF=Ac+Ad+Ag+Ah

the focus error signal FE is:

FE=(Ac+Ah)−(Ad+Ag)

and the tracking error signal TE is:

TE=B−C

These read signal RF, tracking error signal TE and focus error signal FE are detected by a calculating unit composed of a plurality of adders and subtracters which are not shown, in the photodetector 16. The read signal RF is supplied to a signal reproduction system (not shown) and the tracking error signal TE and the focus error signal FE are supplied to a servo circuit (not shown). Based on the tracking error signal TE and the focus error signal FE, the servo circuit controls the objective lens 15 in the focusing direction and tracking direction so as to meet the position of a light spot on the information track through an actuator (not shown) configured with a magnetic circuit and coils.

According to the embodiment of the present invention described above, when the pickup apparatus using the light emitting device having the two light emitting portions carries out focus servo adjustment in the astigmatism method, each of the two laser beams can be received in the case where an appropriate focus error signal is available.

That is, if the tangential line of the track, where a spot is formed, does not corresponds to the center parting line of four-divided light receiving elements for detecting a focus error, offset is unavoidably added to the focus error signal when the tracking is missed. According to the present invention, each of the two laser beams, however, can be received in the case where the tangential line of the track on which a spot is formed corresponds to the center parting line of a light receiving element for detecting a focus error even though the light receiving element is simplified as an eight-divided surface of 4 rows by 2 columns. The light receiving element having simple configuration can still obtain an appropriate focus error signal even when a tracking error occurs.

Although the semiconductor laser device 11 is provided with the two light emitting points A1 and A2 having different emission wavelengths in the embodiment described above, the present invention is also applicable to the case where one monolithic laser device is provided with three or more light emitting points having different emission wavelengths from each other. Three or more light emitting points having different emission wavelengths from each other are arranged on the same straight line. If the straight line and a straight line parallel to the surface of a common electrode form an angle 01 and the major axis of an elliptic spot light formed on the track of an optical disc and the tangential line of the track form an angle θ2, the relation of θ1+θ2=90° is established in a similar manner to the above embodiment.

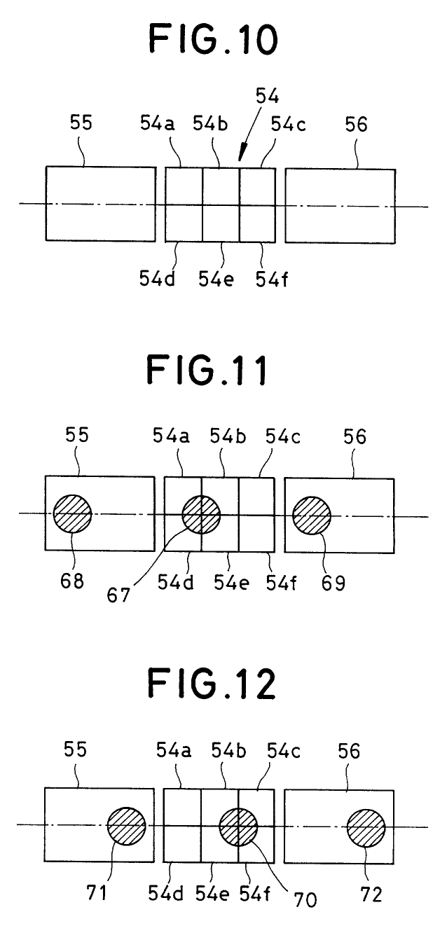

Although the light receiving surface of the light receiving element 51 of the photodetector 16 is divided into eight, it may be divided into six. That is, the photodetector 16 consists of light receiving elements 54 to 56 placed in a line in the longitudinal direction thereof as shown in FIG. 10. The light receiving element 54 is situated between the light receiving elements 55 and 56. The light receiving surface of the light receiving element 54 is divided into six by the parting line for halving it in the longitudinal direction and the parting lines perpendicular thereto for trisecting. The light receiving element 54 has six light receiving elements 54a to 54f. An output signal is generated from each of the six light receiving elements 54a to 54f corresponding to light receiving intensity on the light receiving surface thereof. In FIG. 10, an alternate long and short dash line shows the center line common to each of the light receiving surfaces of the light receiving elements 54 to 56.

A description will be given on the light receiving operation of the photodetector 16 having such six-divided light receiving element 54. The first laser beam having the wavelength of 650 nm is emitted from the first light emitting portion 21. When an elliptic light spot formed by the first laser beam on the recording surface of the disc 17 is focused and positioned on a track, round light spots 67 to 69 are formed on the light receiving surfaces of the light receiving elements 54 to 56 respectively at the photodetector 16 as shown in FIG. 11. The round light spot 67 having the center thereof at the center of the division crossing of light receiving surfaces of the light receiving elements 54a, 54b, 54d, and 54e is formed at the light receiving element 54. At the light receiving elements 55 and 56, the round light spots 68 and 69 are formed at positions respectively separated by predetermined intervals from the light spot 67 of the light receiving element 54. That is, the light spot 68 is positioned on the opposite side to the light receiving element 54 from the center in the longitudinal direction on the light receiving surface of the light receiving element 55. The light spot 69 is positioned on the side of the light receiving element 54 from the center in the longitudinal direction on the light receiving surface of the light receiving element 56.

When the second laser beam having the wavelength of 780 nm is emitted from the second light emitting portion 22 and an elliptic light spot formed on the recording surface of the disc 17 by the second laser beam is focused and positioned on a track, round light spots 70 to 72 are formed on the light receiving surfaces of the light receiving elements 54-56 respectively at the photodetector 16 as shown in FIG. 12. The round light spot 70 having the center thereof at the center of the division crossing of the light receiving surfaces of the light receiving elements 54b, 54c, 54e, and 54f is formed at the light receiving element 54. At the light receiving elements 55 and 56, the round light spots 71 and 72 are formed at positions respectively separate by predetermined intervals from the light spot 70 of the light receiving element 54. That is, the light spot 71 is positioned on the side of the light receiving element 54 from the center in the longitudinal direction on the light receiving surface of the light receiving element 55. The light spot 72 is positioned on the opposite side to the light receiving element 54 from the center in the longitudinal direction on the light receiving surface of the light receiving element 56.

A read signal RF and a focus error signal FE are generated in accordance with output signals of the light receiving elements 54a to 54f. A tracking error signal TE is generated in accordance with output signals of the light receiving elements 55 and 56. Assuming that the output signals of the light receiving elements 54a to 54f are Aa to Af in that order and the output signals of the light receiving elements 55 and 56 are B and C in that order, when the first laser beam having the wavelength of 650 nm is emitted from the first light emitting portion 21, the read signal RF is as follows:

RF=Aa+Ab+Ad+Ae

the focus error signal FE is:

FE=(Aa+Ae)−(Ab+Ad)

and the tracking error signal TE is:

TE=B−C

When the second laser beam having the wavelength of 780 nm is emitted from the second light emitting portion 22, the read signal RF is:

RE=Ab+Ac+Ae+Af

the focus error signal FE is:

FE=(Ab+Af)−(Ac+Ae)

and the tracking error signal TE is:

TE=B−C

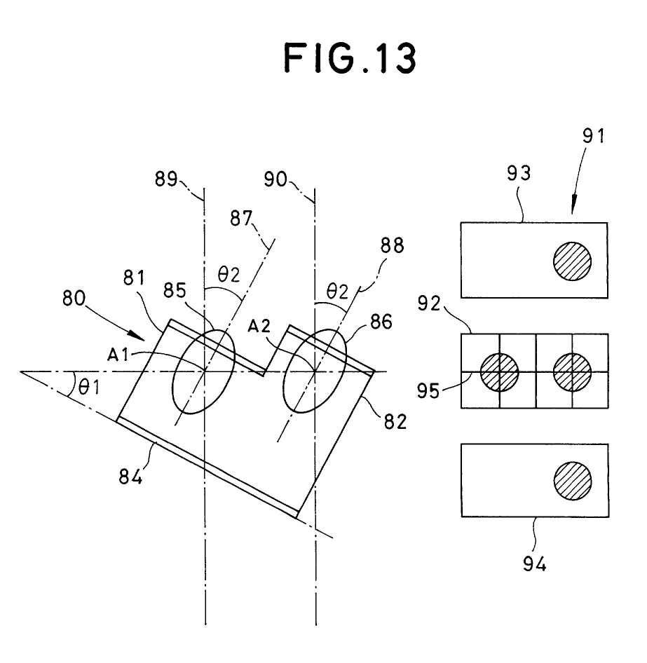

In the embodiment described above, the semiconductor laser device 11 is installed so that the sum of the angle 01, which is formed by a straight line connecting the first light emitting point A1 and the second light emitting point A2 and a straight line parallel to the surface of the common electrode 24, and the angle θ2, which is formed by the major axis of an elliptic spot light formed on the track of the optical disc 17 and the tangential line of the track, becomes a predetermined angle (for example, 90°), and the light receiving element 51 is placed so as to make the center parting line parallel to a tangential line 28 of the track on the light receiving surface thereof. The present invention is not limited to this configuration but possible to be configured as shown in FIG. 13. That is, a semiconductor laser device 80 having a configuration similar to the semiconductor laser device 11 is placed so that the angle η1, which is formed by a straight line 83 connecting first and second light emitting points A1 and A2 of a plurality of first and second light emitting portions 81 and 82 and a straight line parallel to the surface of a common electrode 84, accords with the angle θ2, which is formed by the major axis lines 87 and 88 of elliptic spots 85 and 86 formed by the first and second laser beams on the optical disc and tangential lines 89 and 90 of the track of the optical disc. A light receiving element 92 of a photodetector 91 for detecting a read signal and focus servo is placed so as to make a center parting line 95 of an eight-divided light receiving surface perpendicular to the tangential lines 89 and 90 of the track. Light receiving elements 93 and 94 for tracking servo are placed so as to be parallel to the center parting line 95 on the both sides of the light receiving element 92.

Although the case where the invention is applied to the infinite optical system using the collimator lens 14 has been shown in the embodiments, it can be also applied to a finite optical system.

As described above, according to the present invention, since light emitting points of a plurality of laminated light emitting portions for emitting laser beams of different wavelengths from each other on a substrate are placed at positions separated by different lengths in the laminate direction from the same plane of the substrate, it is possible to make the sum of an angle formed by the major axis line of an elliptic spot formed on the recording medium by a laser beam and the tangential line of the track of the recording medium and an angle formed by the same plane and a straight line connecting light emitting points of each of a plurality of light emitting portions a predetermined angle. With this configuration, when four-divided light receiving portions corresponding to the respective laser beams having the different wavelengths are placed in a photodetector, the center parting lines of light receiving surfaces in the array direction of each of the four-divided light receiving portions can be placed to form the same straight line. Accordingly, the construction of the optical pickup apparatus can be simplified and miniaturized.

What is claimed is:

1. A laser diode chip for an optical pickup apparatus in which a plurality of light emitting portions having laminate structures are formed on a substrate for emitting laser beams of different wavelengths,
wherein respective light emitting points of said plurality of light emitting portions are located at positions separated by different lengths in the laminate direction from the same plane of said substrate.

2. A laser diode chip according to claim 1, wherein
said plurality of light emitting portions are formed on one side of the substrate and a common electrode is formed on the other side of the substrate.

3. A laser diode chip according to claim 1, wherein
an auxiliary substrate is inserted between at least one light emitting portion of said plurality of light emitting portions and the substrate, and the light emitting points of said plurality of light emitting portions are located at the positions separated by said different lengths in the laminate direction from the same plane of said substrate by inserting said auxiliary substrate.

4. A laser diode chip according to claim 1, wherein
the light emitting points of said plurality of light emitting portions are arranged on the same straight line when said plurality of light emitting portions consist of three or more light emitting portions.

5. An optical pickup apparatus comprising:
a light emitting device in which a plurality of light emitting portions having laminate structures for emitting laser beams having different wavelengths are formed on a substrate and the laser beams are selectively emitted from one of said plurality of light emitting portions; and
an optical system for guiding the laser beams emitted from said light emitting device to a recording surface of a recording medium and guiding a laser beam reflected by the recording surface of said recording medium to a photosensing device,
wherein respective light emitting points of said plurality of light emitting portions are located at positions separated by different lengths in the laminate direction from the same plane of said substrate,
said optical system includes an astigmatism element for supplying astigmatism to said laser beam,
said light detecting device has four-split light receiving portions corresponding to the respective laser beams having the different wavelengths in an arranged manner, and all the center parting lines of the light receiving surfaces in the array direction of the respective four-split light receiving portions are arranged to form the same straight line,
said light emitting device is placed so that the sum of an angle formed by the major axis line of an elliptic spot formed on said recording medium by the laser beam and the tangential line of the track of said recording medium and an angle formed by said same plane and a straight line connecting the light emitting points of said plurality of light emitting portions becomes a predetermined angle, and
said light detecting device is placed to make said center parting line parallel to the tangential line of said track on said light receiving surface.

6. An optical pickup apparatus according to claim 5, wherein
the light receiving surface of said light detecting device is divided into eight and a half of the eight-divided light receiving surface corresponds to a laser beam from one of said plurality of light emitting portions and the other half of the eight-divided light receiving surface corresponds to a laser beams from the light emitting portion adjoining said one light emitting portion of said plurality of light emitting portions.

7. An optical pickup apparatus according to claim 5, wherein
the light receiving surface of said light detecting device is divided into six and a four-divided light receiving surface which enclose one division crossing of two division crossings of the six-divided light receiving surface, corresponds to a laser beam from one of said plurality of light emitting portions and a four-divided light receiving surface which enclose the other division crossing of the two division crossings corresponds to a laser beam from the light emitting portion adjoining said one light emitting portion of said plurality of light emitting portions.

8. An optical pickup apparatus according to claim 5, wherein
said optical system has a three-beam generating device for converting each of the laser beams to three beams including 0th order light, ±high-order lights,
said light detecting device has two sub-light receiving portions between which said four-split light receiving portions are placed, in the array direction of said four-split light receiving portions, and each of said sub-light receiving portions has a light receiving area for receiving high-order light formed by said laser beams of all the different wavelengths.

9. An optical pickup apparatus according to claim 5, wherein said predetermined angle is a 90-degree angle.

10. An optical pickup apparatus according to claim 5, wherein
when said plurality of light emitting portions includes three or more light emitting portions, respective light emitting points of said plurality of light emitting portions are arranged on the same straight line.

11. An optical pickup apparatus comprising:
a light emitting device in which a plurality of light emitting portions having laminate structures for emitting laser beams having different wavelengths are formed on a substrate and the laser beams are selectively emitted from one of said plurality of light emitting portions; and
an optical system for guiding the laser beams emitted from said light emitting device to a recording surface of a recording medium and guiding a laser beam reflected by the recording surface of said recording medium to a photosensing device,
wherein respective light emitting points of said plurality of light emitting portions are located at positions separated by different lengths in the laminate direction from the same plane of said substrate,
said optical system includes an astigmatism element for supplying astigmatism to said laser beam,
said light detecting device has four-split light receiving portions corresponding to the respective laser beams having the different wavelengths in an arranged manner, and all the center parting lines of the light receiving surfaces in the array direction of the respective four-split light receiving portions are arranged to form the same straight line,
said light emitting device is placed so that an angle formed by the major axis line of an elliptic spot formed on said recording medium by the laser beam and the tangential line of the track of said recording medium is equal to an angle formed by said same plane and a straight line connecting the light emitting points of said plurality of light emitting portions, and
said light detecting device is placed to make said center parting line perpendicular to the tangential line of said track on said light receiving surface.
